(19) United States
(12) Patent Application Publication
(10) Pub. No.: US 2026/0316202 A1
(43) Pub. Date: Oct. 15, 2026

(54) JOINING SYSTEM AND METHOD FOR FEEDING FASTENERS

(71) Applicant: NEWFREY LLC, New Britain, CT (US)

(72) Inventors: Timo KOHLSTÄDT, Gießen (DE); Hubert IVO, Gießen (DE); Michael MEIER, Gießen (DE); Stefan LIPPERT, Gießen (DE); David HISSERICH, Gießen (DE); Uwe HETT, Gießen (DE); Adrian BECKER, Gießen (DE); André ATZBACH, Gießen (DE)

(21) Appl. No.: 19/551,755

(22) Filed: Feb. 27, 2026

Related U.S. Application Data
(63) Continuation of application No. PCT/EP2024/078447, filed on Oct. 9, 2024.

(30) Foreign Application Priority Data
Oct. 10, 2023 (EP) 23202580.9

(51) Int. Cl. B23P 19/00; B21J 15/32; B23K 9/20; B25B 23/04

(52) U.S. Cl. CPC B23P 19/005; B21J 15/32; B23K 9/206; B25B 23/04

(57) ABSTRACT

A method for feeding fasteners and a joining system for joining a fastener to a workpiece includes a head having a nose with a holding arrangement for receiving the fastener destined to be joined to the workpiece. The joining system includes a feeder for feeding fasteners from a magazine to the holding arrangement, wherein the feeder comprises a feeding tube adapted to receive fasteners from a magazine and into which the fasteners are driven to the nose. An air supply mechanism comprises a compressed air source for delivering compressed air to the feeder and driving the fastener within the feeding tube from the magazine to the holding arrangement. The air supply mechanism further comprises a plurality of valves arranged such that a plurality of compressed air pulses are provided for moving the fastener within the feeding tube from the magazine to the holding arrangement.

### CROSS-REFERENCE TO RELATED APPLICATIONS

This application is a bypass continuation of International Patent Appl. No. PCT/EP2024/078447, filed Oct. 9, 2024, published as WO 2025/078469, which claims the benefit and priority of European Patent App. Ser. No. 23202580.9, filed Oct. 10, 2023, the entire disclosures of which are incorporated herein by reference.

### TECHNICAL FIELD

The present invention relates to a joining system for joining a fastener to a workpiece and to a method for feeding fasteners into the nose of a joining head by compressed air.

### BACKGROUND

In the present context, the terms “fastening” or “joining” are intended to refer to all methods for attaching elements to components, in particular attaching metal or plastic elements to metal or plastic components, for example by adhesive bonding, screwing, by forming, such as riveting, self-piercing riveting, blind riveting of rivets or nuts, clinch riveting, or by the union of materials, such as welding, including short-cycle arc welding or drawn-arc welding. Short-cycle arc welding is frequently referred to as stud welding, even though studs are not the only parts welded in this manner.

Self-piercing rivets and associated tools or apparatus for fastening two or more pieces of material with respect to one another are generally well-known in the automotive industry. Self-piercing rivets have typically been used in non-critical connections attaching two or more pieces of material with respect to one another, for instance to assemble an automotive body at a framing station using self-piercing rivets.

Stud welding is used primarily, but not exclusively, in automotive production. In this context, metal elements, such as metal studs with and without threads, eyes, nuts, etc., are welded onto the sheet metal or workpiece of a vehicle body. The metal elements then serve as anchors or mounting elements, for example for attaching passenger compartment fittings, lines, wiring and the like, to the body metal. The metal elements may be welding studs that have a shank, and a head somewhat larger in diameter than the stud shank. The head is welded to the workpiece.

Such joining or fastening apparatus are commonly attached to a movable frame, in particular to a robot and comprise a joining head with a nose having a holding arrangement for receiving and holding a joining element destined to be joined to a workpiece. A drive mechanism can move the holding arrangement along a joining direction for joining the fastener to the workpiece.

Once a fastener is arranged in the holding arrangement, a conventional fastening or joining method can be carried out. For example, a conventional stud welding process, preferably in the drawn arc method, can be carried out as follow. The fastener is first placed on the workpiece by means of the drive mechanism and the holding arrangement. Then a pre-conduction electric current is switched on, which flows through the fastener and the workpiece. Next, the fastener (or stud) is raised with respect to the component by means of the drive mechanism (for instance the drive mechanism is a linear drive). An electric arc forms. The system then switches to the welding current. The end faces of the fastener and workpiece (or component) opposite one another begin to melt as a result of the high welding current. Then the fastener is lowered onto the workpiece again so that the two melts combine. The welding current is switched off upon contact with the component and short-circuiting of the arc, or shortly beforehand. All the molten material solidifies, and the weld connection is established.

The fastener needs to be supplied to the joining head and the holding arrangement. To this end, a feeder is provided with a feeding tube for feeding the fastener (or joining elements) from a magazine to the holding arrangement. Typically, a stationary supply device separates the fasteners and then conveys them to the joining head by means of compressed air via a feeding tube. Individually separated fasteners such as studs are blown through the feeding tube or feeding hose by means of compressed air from the magazine toward the joining head.

While compressed air is widely used in such joining systems for the feeding of fasteners, there are a few disadvantages associated with this method. Compressed air systems are known to be less energy-efficient compared to other power sources. The process of compressing air requires a significant amount of energy, and there can be energy losses during transmission and conversion. This inefficiency can result in higher energy consumption and increased operating costs.

To promote energy saving and “green manufacturing” in joining systems, it is important to consider alternative power sources or improve the efficiency of compressed air systems, and implement measures to reduce energy waste and environmental impact.

Various solutions have been proposed to remedy these problems.

US2018222696A1 discloses a joining apparatus in which the supply of compressed air may be interrupted at the end of fastener's travel along a feeding tube using residual momentum and gravity to ensure that the fastener reaches the joining head. A joining element passage sensor is provided such that the compressed air is switched off when the sensor detects the presence of a fastener.

Such systems allows decreasing the compressed air consumption. However, a particular design of the supply or feeding apparatus is necessary.

### SUMMARY

It is thus an object of the present invention to provide a joining system and a method for feeding fasteners that enhances energy consumption savings and offers modularity.

Accordingly, the present invention provides a joining system according to claim 1.

More particularly, the present invention is directed to a joining system for joining a fastener to a workpiece comprising:
a head having a nose with a holding arrangement for receiving the fastener destined to be joined to the workpiece,
a feeder for feeding fasteners from a magazine to the holding arrangement, wherein the feeder comprises a feeding tube adapted to receive fasteners from a magazine and into which the fasteners are driven to the nose;
an air supply mechanism comprising a compressed air source for delivering compressed air to the feeder and driving the fastener within the feeding tube from the magazine to the holding arrangement,
wherein
the air supply mechanism further comprises a plurality of valves arranged such that a plurality of compressed air pulses is provided for moving the fastener within the feeding tube from the magazine to the holding arrangement.

By avoiding a continue compressed air flow within the feeding hose, a significant reduction of the compressed air consumption is realized without impacting substantially the cycle time or the joining element delivery. Besides, the compressed air pulses can be adapted to different geometry of feeding tube or fastener, due to the presence of several valves. Eventually, a pre-determined compressed air pulse profile may be defined.

According to a disclosure of the present application, the joining system may comprise:
a head having a nose with a holding arrangement for receiving the fastener destined to be joined to the workpiece,
a feeder for feeding fasteners from a magazine to the holding arrangement, wherein the feeder comprises a feeding tube adapted to receive fasteners from a magazine and into which the fasteners are driven to the nose;
an air supply mechanism comprising a compressed air source for delivering compressed air to the feeder and driving the fastener within the feeding tube from the magazine to the holding arrangement,
wherein
the air supply mechanism further comprises a fast-acting valve. The fast-acting valve can open and close in a matter of milliseconds or even microseconds, enabling rapid adjustments and precise flow control. The fast-acting valve forms a pulsed valve.

In an embodiment, the air supply mechanism comprises at least:
a first valve and a second valve connected in parallel,
a third valve connected in series with the first and second valves.

The different valves have different configurations or properties allowing to provide a modular compressed air profile adapted to drive the fastener from the magazine to the joining head (or more particularly from a first end of the feeding tube to a second end of the feeding tube).

In an embodiment, the air supply mechanism comprises a throttle, and the first valve is adjustable via the throttle. The second valve is an unthrottled valve. Both valves in parallel are configured to supply the third valve with maximum air volume during a pulse.

In an embodiment, the air supply mechanism comprises at least one fast-acting valve, and the third valve is a fast-acting valve. The fast-acting valve can open and close in a matter of milliseconds or even microseconds, enabling rapid adjustments and precise flow control. Thus, the third valve is a pulsed valve.

In an embodiment, the air supply mechanism comprises a sensor unit for recording air consumption data and/or for detecting the presence of a fastener in the feeding tube. With the consumption data recording, an abnormal consumption can be seen directly and addressed. With the presence sensor, the compressed air can be accurately switched on and off on a need basis, avoiding losses.

The present invention is also directed to a method for feeding fasteners into a nose of a joining head comprising the following steps:
Providing a joining system as disclosed,
Providing a fastener and feeding the fastener with the feeder such that the fastener is moved up to the nose with pulsed air coming from the air supply mechanism such that:
   in a feeding stage the motion of the fastener is controlled by pulsed air;
   in an arrivalstage the feeding of the fastener into the nose is controlled and at least one valve is switched off.

The different feeding stages are completely adjustable due to the presence of the air supply mechanism with the plurality of valves. For instance, in a first stage, before the feeding stage, a smooth controlled acceleration of the fastener may be realized. This first stage may for instance be implemented in particular when the fastener is a rivet. When the fastener is for instance a weld stud, there might be no need to have an acceleration and the weld stud may directly be driven according the pulsed profile with a full compressed air flow during the pulses.

In an embodiment, the air supply mechanism comprises a first valve and a second valve connected in parallel, and a third valve connected in series with the first and second valves. In an embodiment, the first and second valves are switched on one after the other in the first stage. In an embodiment, the first and second valves are open and the third valve is pulsed with a predetermined pulse sequence in the second stage. In an embodiment, the second and third valves are switched off one after the other, the first ventil remaining switched on, in the third stage.

In an embodiment, a sensor unit detects the presence of a fastener in the feeder. Thus, the start of the compressed air pulsed sequence is precise.

In an embodiment, a control unit regulates the opening and the closing of the valves depending on the data sent by the sensor unit.

In an embodiment, a control unit regulates the opening and closing of the valves according to a predetermined given sequence.

### BRIEF DESCRIPTION OF THE DRAWINGS

The invention and its advantages will be better understood from the reading of the following description, given by way of example only and with reference to the accompanying drawings, of which:

FIG. 1 shows a schematic perspective view of a joining system, notably a stud welding system comprising a joining head with a holding arrangement, a feeder, a drive mechanism and an air supply mechanism;

FIG. 2 shows schematically the arrangement of the valves of the air supply mechanism;

FIG. 3A, FIG. 3B and FIG. 3C show a time-lapse diagram, wherein the X-axis represents time, and it illustrates the detection of the fastener at the entry of the feeding tube and at the outlet of the feeding tube (FIG. 3A, FIG. 3B and FIG. 3C), the switching on and off of the first valve (FIG. 3A), the switching on and off of the second valve (FIG. 3B) and the switching on and off of the third valves (FIG. 3C).

### DETAILED DESCRIPTION

The embodiments of the disclosure will be best understood by reference to the drawings, wherein the same reference signs designate identical or similar elements. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations.

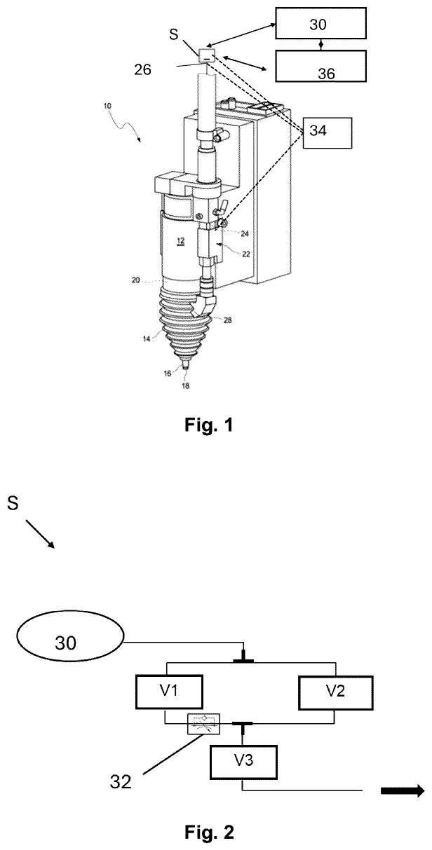

FIG. 1 shows a joining system 10 according to the invention. The joining system 10 is adapted to be driven by a robot (not represented) with a stationary base from which two arms extend, articulately connected to each other. A flange may be provided at an end of the arm, and the joining system 10 can be attached to said flange. The joining system 10 comprises a joining head 12. The joining head 12 is provided with a nose 14 with a holding arrangement 16. The holding arrangement 16 is configured to receive a fastener 18 destined to be joined to a component or a workpiece. The fastener 18 is for example a stud, such as a weld stud or a glue stud. In other embodiments, the joining element can be a rivet, a self-piercing rivet, a self-coring rivet, a self-flowing rivet, a blind rivet, a nut, a blind nut, a screw . . . etc. The holding arrangement 16 is for example a holding element for holding the joining element (or fastener) before and/or during the joining step. If the joining element is a weld stud, the holding arrangement may be a stud holder. The holding arrangement 16 may also be a receiver, notably if the joining element is a rivet. Although the joining system 10 may be employed for numerous kinds of joining as a matter of design, the joining system 10 illustrated in FIG. 1 serves more particularly to weld a fastener 18, in particular a welding stud, to a workpiece, for example a metal sheet. A conformation of the joining system as a bolt-welding system, or short-time arc-welding system with lift ignition, is especially preferred, without loss of generality.

The joining system 10 (or more particularly the joining head 12) may further comprise a drive mechanism 20 adapted to move the holding arrangement 16 along a joining direction for joining the fastener to the workpiece.

A feeder 22 is also provided. The feeder 22 comprises a feeding tube 24 (also called feeding hose or feeding channel) adapted to receive the fastener from a magazine M and into which the fastener moves from a first end 26 to a second end 28. More particularly, the first end is toward the magazine, wherein the second end is toward the nose of the joining head or the holding arrangement or a receiver. At the second end 28, the feeding tube 24 communicates with the holding arrangement 16 for the passage of the joining element 18 from the feeding tube 24 to the holding arrangement 16. Compressed air is used to propel and guide the fastener from the magazine or the first end of the feeding tube towards the second end of the feeding tube or the holding arrangement or the nose.

The feeding tube 24 receives isolated fasteners 18 and each fastener 18 is driven by compressed air from the air supply mechanism S. The air supply mechanism comprises a compressed air source 30 and at least a valve, and more particularly a plurality of valves V1, V2, V3. More particularly, the air supply mechanism comprises a first, a second and a third valve V1, V2, V3.

As shown in FIG. 2, the first and second valves V1, V2 are arranged in parallel, wherein the third valve V3 is connected in series with the first and the second valve V1, V2, at the exit of the first and second valves V1, V2. The first valve V1 may be adjusted via a throttle 32. The second valve V2 is an unthrottled valve.

The third valve V3 is for instance a fast-acting pulsed valve. The fast-acting valve can open and close in a matter of milliseconds or even microseconds, enabling rapid adjustments and precise flow control. Thus the third valve may deliver pulsed compressed air to the feeding tube 24. In an embodiment, the air supply mechanism may be provided only with one valve which is a fast-acting valve.

The particular arrangement of the first, second and third valves V1, V2, V3 allows adjusting the compressed air, and more particularly a supply of pulsed compressed air, through the third valve, adapted to different stage of the fastener position within the feeding tube. The air supply mechanism S delivers a particular compressed air sequence or profile adapted to move the fastener from the first end to the second end without a continuous compressed air flow within the feeding tube.

The joining system 10 may be provided with a sensor unit 34. The sensor unit 34 may comprise a presence sensor at the first end 26 of the feeding tube 24. A second presence sensor may be provided at the second end 28 of the feeding tube 24. A sensor for recording the air consumption data may also be provided. The recorded air consumption data may be used for instance to detect a possible defect or to adjust the compressed air delivery sequence.

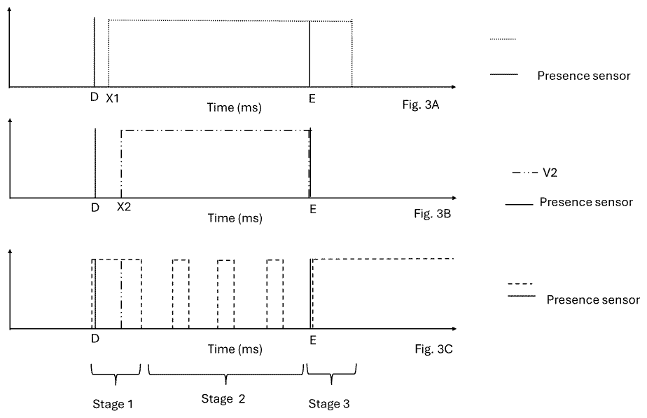

The compressed air delivery sequence is more particularly depicted in FIG. 3A, FIG. 3B and FIG. 3C. FIG. 3A, FIG. 3B and FIG. 3C are diagrams showing on the X-axis the time.

In FIG. 3A, one can see the detection of a fastener at the first end of the feeding tube (D) and at the second end of the feeding tube (E). The dotted line in FIG. 3A represents the status of the first valve V1. The first valve is switched on shortly after the detection of the fastener at the first end of the feeding tube at X1. The first valve V1 is switched off shortly after the detection of the fastener at the second end of the feeding tube.

In FIG. 3B, one can see the detection of the fastener at the first end of the feeding tube (D) and at the second end of the feeding tube (E). The mixed line in FIG. 3B represents the command of the second valve V2. The second valve is switched on after the first valve V1 at X2. The second valve is switched off before the first valve V1 when the fastener has been detected at the second end of the feeding tube.

In FIG. 3C, one can see the detection of the fastener at the first end of the feeding tube (D) and at the second end of the feeding tube (E). The dashed line in FIG. 3C represents the command of the third valve V3. The third valve V3 opens and closes during the motion of the fastener within the feeding tube in order to deliver a pulsed compressed air to drive the fastener during its entire stroke of the fastener within the feeding tube.

In another embodiment, the first valve may be switched on first, before the signal of the presence sensor at the first end of the feeding tube. In this case, for example, after the signal of the presence sensor at the first end of the feeding tube, the second and the third valve are switched on. In a yet another embodiment, the third valve may be switched on first, before the signal of the presence sensor at the first end of the feeding tube. In this case, for example, after the signal of the presence sensor at the first end of the feeding tube, the second and the first valves may be switched on.

First and second valves V1, V2 are at the outlet of the compressed air source and supply the third valve (which is a fast-cycle valve) with a maximum air volume during the cycle (the motion of the fastener from the first to the second end). The outlet of the third valve cooperates with the feeding tube and several air pulsations are delivered in order to move the fastener from the first end to the second end.

The combination and interconnection of the valves makes it possible to divide the entire feeding process into stages or phases and adapt it to different feeding conditions.

For instance, two or three main stages may be realized. The first stage (which is optional and for instance more relevant for certain types of fasteners such as rivets or self-piercing rivets, and less relevant for fasteners such as weld studs) corresponds to the start of the feeding (the fastener is at the first end of the feeding tube). A gentle, controlled acceleration is possible by switching on first and second valves V1, V2, one after the other after a predetermined time (X2-X1). The stage 2 (corresponding to a feeding stage) is a pulsed feeding sequence with the first and second valves V1, V2 switched on and the third valves being in a pulsed mode, switching on and off regularly with a predetermined rhythm. The switching off and on rhythm is automated and may be dependent on the length of the feeding tube and/or fastener and/or the requested feeding pace or speed. The third stage (or arrival stage) corresponds to a controlled feed into the nose, by switching off the second and third valves V2, V3, successively after a predetermined time and after the detection of the fastener at the second end, the feeding is then realized exclusively via the throttled valve V1 (thus, the feed speed is adjustable).

A control unit 36 can command the air supply mechanism S. The control unit may be self-referencing in terms of the feeding time. The control unit controls the feeding time and air consumption through the pulse ratio of the third valve. The process may be customized depending on the needs (air consumption or time optimization).

1. A joining system for joining a fastener to a workpiece comprising:
a head having a nose with a holding arrangement for receiving the fastener destined to be joined to the workpiece,
a feeder for feeding fasteners from a magazine to the holding arrangement, wherein the feeder comprises a feeding tube adapted to receive fasteners from a magazine and into which the fasteners are driven to the nose;
an air supply mechanism comprising a compressed air source for delivering compressed air to the feeder and driving the fastener within the feeding tube from the magazine to the holding arrangement, and
the air supply mechanism further comprising a plurality of valves arranged such that a plurality of compressed air pulses is provided for moving the fastener within the feeding tube from the magazine to the holding arrangement.

2. The joining system according to claim 1, wherein the air supply mechanism comprises at least:
a first valve and a second valve connected in parallel, and
a third valve connected in series with the first and second valves.

3. The joining system according to claim 2, wherein the air supply mechanism comprises a throttle, and wherein the first valve is adjustable via the throttle, wherein the second valve is an unthrottled valve.

4. The joining system according to claim 1, wherein the air supply mechanism comprises at least one fast-acting valve, and wherein the third valve is a pulsed valve.

5. The joining system according to claim 1, wherein the air supply mechanism comprises a sensor unit for measuring air consumption or detecting the presence of a fastener in the feeding tube.

6. A method for feeding fasteners into a nose of a joining head comprising the following steps:
providing a joining system according to claim 1,
providing a fastener and feeding the fastener with the feeder such that the fastener is moved up to the nose with pulsed air coming from the air supply mechanism such that:
in a feeding stage the motion of the fastener is controlled by pulsed air; and
in an arrival stage the feeding of the fastener into the nose is controlled and at least one valve is switched off.

7. The method according to claim 6, wherein the air supply mechanism comprises a first valve and a second valve connected in parallel, and a third valve connected in series with the first and second valves.

8. The method according to claim 7, wherein in the first stage the first and second valves are switched on one after the other after predetermined time X.

9. The method according to claim 7, wherein in the second stage, the first and second valves are switched on and the third valve is pulsed with a predetermined pulse rhythm.

10. The method according to claim 7, wherein in the third stage the second and third valves are switched off one after the other, the first ventil remaining switched on.

11. The method according to claim 6, wherein a sensor unit detects the presence of a fastener in the feeder.

12. The method according to claim 11, wherein a control unit regulates the opening and the closing of the valves depending on the data sent by the sensor unit.

13. The method according to claim 6, wherein a control unit regulates the opening and closing of the valves according to a predetermined given sequence.
